(19) United States
(12) Patent Application Publication
(10) Pub. No.: US 2012/0113246 A1
(43) Pub. Date: May 10, 2012

(54) LINE-WIDTH INSPECTION DEVICE

(75) Inventors: Chengming He, Guangdong (CN); Yung-yu Lin, Guangdong (CN)

(73) Assignee: SHENZHEN CHINA STAR OPTOELECTRONICS TECHNOLOGY CO., LTD., Shenzhen (CN)

(21) Appl. No.: 12/997,890

(22) PCT Filed: Nov. 26, 2010
(86) PCT No.: PCT/CN10/79153

§ 371 Date: Dec. 14, 2010

(30) Foreign Application Priority Data
Nov. 4, 2010 (CN) 201010533817.7

(51) Int. Cl. H04N 7/18

(52) U.S. Cl. 348/87; 348/E07.085

(57) ABSTRACT

The present invention discloses a line-width inspection device. The line-width inspection device has a platform, an image capturing device, a main light source device and at least one compensation light source device. The image capturing device is mounted above the platform, aligned with an inspection area of the platform and captures images of a pattern under inspection in the inspection area. The main light source device is disposed above the platform and correspondingly provides forward illumination to the inspection area, and an incident direction thereof is perpendicular to the platform. The at least one compensation light source device is mounted above the platform and provides compensation illumination to the inspection area. The additional compensation light source device can prevent edges of the pattern under inspection from occurring shadows and affecting image capturing, so as to enhance precision of image capturing.

### FIELD OF THE INVENTION

The present invention relates to a line-width inspection device, and more particularly to a line-width inspection device that increases compensation light sources to prevent from occurring shadows at edges of patterns under inspection and affecting image capturing.

### BACKGROUND OF THE INVENTION

With the development of semiconductor manufacturing process, integrated circuit elements are progressively made much smaller. Therefore, in the semiconductor manufacturing process, control of critical dimension, such as line width, line pitch, etc. of fine circuit patterns on masks or wafers, is an important key point. Generally, manufacturers use line-width inspection device to inspect critical dimensions of circuit patterns, the line-width inspection device can be used to inspect if the line width or pitch is precise without deviation.

With reference to FIG. 1, FIG. 1 is a schematic view of performing line-width inspection according to a conventional technology. The conventional technology uses an image capturing device 91 (such as a CCD camera) to capture images from a pattern 92 under inspection, and then performs line-width inspection through computer processing. The image capturing device is usually assembled together with a light source device 90. The light source device 90 provides illumination in a forward direction on a top of the pattern under inspection, so that the image capturing device is able to capture clear images.

However, with the decrease in dimensions of semiconductors, tolerable line-width deviation in manufacturing processes is getting smaller. Therefore, the line-width inspection technology still has following problems in practical use: since the light source device 90 vertically projects on the pattern under inspection in a radial manner, such that edges of the pattern 92 under inspection may not be lighted by the light source device 90 due to a thickness, and lead to an occurrence of shadows. With reference to FIG. 2, the line-width inspection requires converting color pictures to grayscale pictures, and the conversion is performed by integral calculation through a computer. When being converted into grayscale values, the shadows will be an oblique line in a curve diagram, which means the edges of the pattern cannot be accurately captured and defined due to the interference of the shadows. Hence, the occurrences of shadows will affect precision of image capturing and cause line-width inspection error.

Hence, it is necessary to provide a line-width inspection device to overcome the problems existing in the conventional technology.

### SUMMARY OF THE INVENTION

A primary object of the invention is to provide a line-width inspection device which increases side light sources to compensate a shadow part of a pattern under inspection for insufficient illumination, so as to enhance precision of an image capturing device thereof that performs image capturing on the pattern under inspection.

To achieve the above object, the present invention provides a line-width inspection device, and the line-width inspection device comprises:
a platform having an inspection area;
an image capturing device mounted above the platform and aligned with the inspection area of the platform, wherein the image capturing device captures images of a pattern under inspection in the inspection area;
a main light source device mounted above the platform, wherein the main light source device correspondingly provides forward illumination to the inspection area, and an incident direction of the illumination is perpendicular to the platform; and
at least one compensation light source device mounted above the platform, wherein the at least one compensation light source device provides compensation illumination to the inspection area.

In one embodiment of the present invention, an incident direction of the at least one compensation light source device is oriented at an oblique angle with respect to the platform.

In one embodiment of the present invention, the oblique angle is ranged between 30 degrees and 60 degrees, such as 45 degrees.

In one embodiment of the present invention, the line-width inspection device comprises two compensation light source devices disposed at two sides of the main light source device, respectively.

In one embodiment of the present invention, the line-width inspection device further comprises a computer, and the computer is connected to the image capturing device to receive images captured by the image capturing device.

In one embodiment of the present invention, the at least one compensation light source device is a light-emitting diode assembly, a cold cathode fluorescent lamp or an incandescent lamp.

In one embodiment of the present invention, the pattern under inspection is a transparent electrode layer of a liquid crystal glass or a black matrix layer of a color filter.

The compensation light source device can compensate shadow parts of the pattern under inspection for insufficient illumination, especially when the compensation light source device is mounted at two sides of the main light source device, the pattern under inspection can obtain sufficient illumination, so as to further enhance precision of the image capturing device performing image capturing on the pattern under inspection.

### DESCRIPTION OF THE DRAWINGS

FIG. 1 is a schematic view of performing line-width inspection according to a conventional technology;

FIG. 2 is a schematic view of a conventional line-width inspection device performing integral image capturing on an edge of a pattern under inspection;

FIG. 3 is a schematic view of a line-width inspection device according to a first embodiment of the present invention;

FIG. 4 is a schematic view of a line-width inspection device in accordance with the present invention performing integral image capturing on an edge of a pattern under inspection; and

FIG. 5 is a schematic view of a line-width inspection device according to a second embodiment of the present invention.

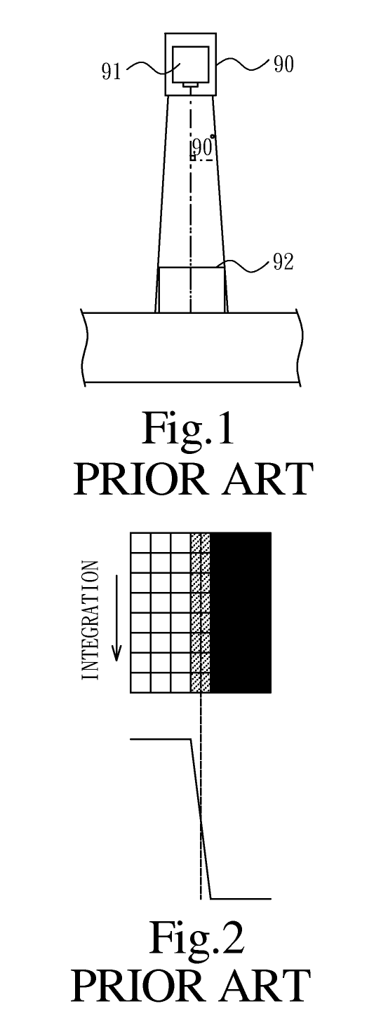

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

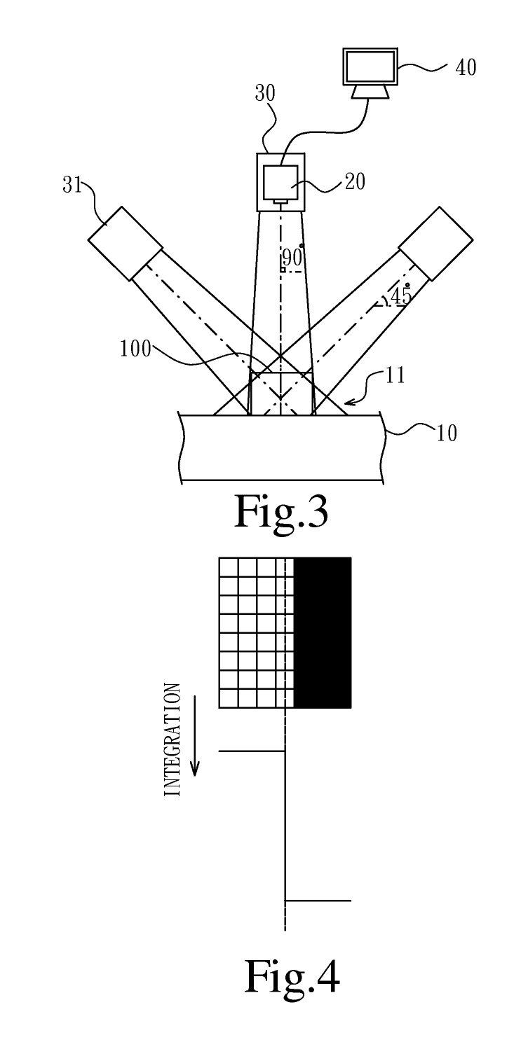

With reference to FIG. 3, FIG. 3 is a schematic view of a line-width inspection device according to a first embodiment of the present invention. The line-width inspection device comprises a platform 10, an image capturing device 20, a main light source device 30 and the at least one compensation light source device 31.

The platform 10 has an inspection area 11, and a surface of the platform 10 is provided for an element pattern 100 under inspection (i.e. to-be-inspected) to be disposed thereon, and the area for disposing is the so-called inspection area 11. The element pattern 100 under inspection mainly refers to related components in liquid crystal display (LCD) field, such as indium tin oxide (ITO) transparent electrode layer of a liquid crystal glass or a black matrix (BM) layer of a color filter (CF), but is not limited thereto.

The image capturing device 20 is mounted above the platform 10 and can be attached to a bracket (not illustrated in Figures) mounted on the platform 10. The image capturing device 20 is aligned with the inspection area 11 of the platform 10 and captures images of the element pattern 100 under inspection in the inspection area 11.

The main light source device 30 is mounted above the platform 10. The main light source device 30 correspondingly provides forward illumination to the inspection area 11, and an incident direction of the forward illumination is perpendicular to the surface of the platform 10. The main light source device 30 may be a light-emitting diode (LED) assembly, a cold cathode fluorescent lamp (CCFL) or an incandescent lamp.

The at least one compensation light source device 31 is mounted above the platform 10. For example, in this embodiment, the line-width inspection device has two compensation light source devices 31 that are disposed at two sides of the main light source device 30, respectively, wherein each of the compensation light source devices 31 may be a light-emitting diode (LED) assembly, a cold cathode fluorescent lamp (CCFL) or an incandescent lamp. The compensation light source devices 31 correspondingly provides compensation illumination to the inspection area 11. An incident direction of each of the compensation light source devices is oriented at an oblique angle with respect to the platform 10, and the oblique angle is ranged between 30 degrees and 60 degrees, especially 45 degrees.

The line-width inspection device further comprises a computer 40. The computer 40 is connected to the image capturing device 20 to receive images captured by the image capturing device 20.

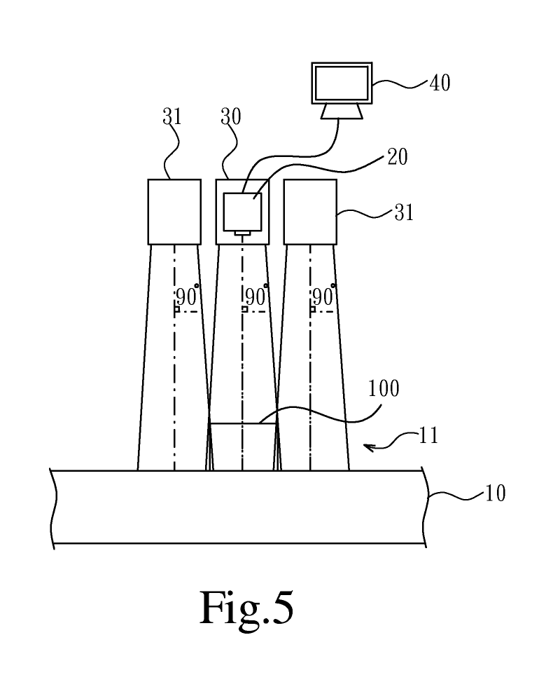

With reference to FIG. 5, FIG. 5 is a schematic view of a line-width inspection device according to a second embodiment of the present invention. The line-width inspection device of the second embodiment of the present invention is similar to the line-width inspection device of the first embodiment of the present invention, so as to use similar terms and numerals of the first embodiment, but the difference of the second embodiment is characterized in that: The incident direction of the compensation light source device 31 is perpendicular to the platform 10. Since the compensation light source device 31 provides a beam of divergent lights, therefore the lights thereof still correspondingly provide compensation illumination to edges of the inspection area 11.

The line-width inspection device of the present invention uses additional illumination by adding the compensation light source device 31 to compensate the edges of the element pattern 100 that cannot be illuminated by the light source on the top. With reference to FIG. 4, when the captured images are converted into grayscale values through computer integral calculation, it can be seen that no shadows occur at an edge of the element pattern 100, and the integral line in grayscale value is a vertical line, which means there is no vague space for defining the edge, and thereby the edge can be accurately defined.

In conclusion, comparing with the conventional line-width inspection device unable to provide full illumination to edges of a pattern under inspection and lead to occurrence of shadows and causing the image capturing precision to be affected. The line-width inspection device of the present in FIG. 3 further mounts at least one compensation light source device 31 beside the main light source device 30 to use additional illumination to compensate the insufficient of illumination at the edge of the element pattern 100 under inspection, and indeed effectively prevent shadows from occurring and then increase precision of the image capturing device 20 performing image capturing on the element pattern 100 under inspection.

The present invention has been described with a preferred embodiment thereof and it is understood that many changes and modifications to the described embodiment can be carried out without departing from the scope and the spirit of the invention that is intended to be limited only by the appended claims.

1. A line-width inspection device comprising:
a platform having an inspection area;
an image capturing device mounted above the platform and aligned with the inspection area of the platform, wherein the image capturing device captures images of a pattern under inspection in the inspection area; and
a main light source device mounted above the platform, wherein the main light source device correspondingly provides forward illumination to the inspection area, and the an incident direction thereof is perpendicular to the platform;
characterized in that: the line-width inspection device further comprises:
two compensation light source devices mounted above the platform and disposed at two sides of the main light source device, respectively, wherein both of the compensation light source devices provide compensation illumination to the inspection area, and an incident direction of each of the compensation light source devices is oriented at an oblique angle with respect to the platform.

2. The line-width inspection device as claimed in claim 1, characterized in that:
the oblique angle is ranged between 30 degrees and 60 degrees.

3. The line-width inspection device as claimed in claim 2, characterized in that:
the oblique angle is 45 degrees.

4. The line-width inspection device as claimed in claim 1, characterized in that:
the line-width inspection device further comprises a computer, and the computer is connected to the image capturing device to receive images captured by the image capturing device.

5. The line-width inspection device as claimed in claim 1, characterized in that:
the main light source device is a light-emitting diode assembly, a cold cathode fluorescent lamp or an incandescent lamp.

6. The line-width inspection device as claimed in claim 1, characterized in that:
each of the compensation light source devices is a light-emitting diode assembly, a cold cathode fluorescent lamp or an incandescent lamp.

7. The line-width inspection device as claimed in claim 1, characterized in that:
the pattern under inspection is a transparent electrode layer of a liquid crystal glass or a black matrix layer of a color filter.

8. A line-width inspection device comprising:
a platform having an inspection area;
an image capturing device mounted above the platform and aligned with the inspection area of the platform, wherein the image capturing device captures images of a pattern under inspection in the inspection area; and
a main light source device mounted above the platform, wherein the main light source device correspondingly provides forward illumination to the inspection area, and an incident direction of the illumination is perpendicular to the platform;
characterized in that: the line-width inspection device further comprises:
at least one compensation light source device mounted above the platform, wherein the at least one compensation light source device provides compensation illumination to the inspection area.

9. The line-width inspection device as claimed in claim 8, characterized in that:
an incident direction of the at least one compensation light source device is oriented at an oblique angle with respect to the platform.

10. The line-width inspection device as claimed in claim 9, characterized in that:
the oblique angle is ranged between 30 degrees and 60 degrees.

11. The line-width inspection device as claimed in claim 10, characterized in that:
the oblique angle is 45 degrees.

12. The line-width inspection device as claimed in claim 8, characterized in that:
the line-width inspection device comprises two compensation light source devices disposed at two sides of the main light source device, respectively.

13. The line-width inspection device as claimed in claim 8, characterized in that:
the line-width inspection device further comprises a computer, and the computer is connected to the image capturing device to receive images captured by the image capturing device.

14. The line-width inspection device as claimed in claim 8, characterized in that:
the main light source device is a light-emitting diode assembly, a cold cathode fluorescent lamp or an incandescent lamp.

15. The line-width inspection device as claimed in claim 8, characterized in that:
the at least one compensation light source device is a light-emitting diode assembly, a cold cathode fluorescent lamp or an incandescent lamp.

16. The line-width inspection device as claimed in claim 8, characterized in that:
the pattern under inspection is a transparent electrode layer of a liquid crystal glass or a black matrix layer of a color filter.
